(19) United States
(12) Patent Application Publication
(10) Pub. No.: US 2007/0259223 A1
(43) Pub. Date: Nov. 8, 2007

(54) Capturing heat from a fuel cell stack

(76) Inventors: Michael Penev, Albany, NY (US); James Carucci, New Hartford, NY (US); Richard H. Cutright, Corinth, NY (US); Christopher J. Chuah, Clifton Park, NY (US); Gregory C. Pacifico, Latham, NY (US)

Correspondence Address: TROP PRUNER & HU, PC, 1616 S. VOSS ROAD, SUITE 750, HOUSTON, TX, 77057-2631, US

(21) Appl. No.: 11/645,003

(22) Filed: Dec. 22, 2006

Related U.S. Application Data
(60) Provisional application No. 60/754,975, filed on Dec. 29, 2005.

(51) Int. Cl. H01M 8/04

(52) U.S. Cl. 429/13; 429/26

(57) ABSTRACT

A technique that is usable with a fuel cell stack includes flowing a fluid through the fuel cell stack to remove thermal energy from the stack. The technique includes flowing the fluid through an expander to produce electrical power.

This application claims the benefit under 35 U.S.C. §119(e) to U.S. Provisional Application Ser. No. 60/754,975, entitled “CAPTURING HEAT FROM A FUEL CELL STACK,” which was filed on Dec. 29, 2005, and is hereby incorporated by reference in its entirety.

### BACKGROUND

The invention generally relates to capturing heat from a fuel cell stack.

A fuel cell is an electrochemical device that converts chemical energy directly into electrical energy. For example, one type of fuel cell includes a proton exchange membrane (PEM), which permits only protons to pass between an anode and a cathode of the fuel cell. Typically PEM fuel cells employ sulfonic-acid-based ionomers, such as Nafion, and operate in the 60° Celsius (C) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, such as a cooling subsystem, a cell voltage monitoring subsystem, a control subsystem, a power conditioning subsystem, etc. The particular design of each of these subsystems is a function of the application that the fuel cell system serves.

### SUMMARY

In an embodiment of the invention, a technique that is usable with a fuel cell stack includes flowing a fluid through the fuel cell stack to remove thermal energy from the stack. The technique includes flowing the fluid through an expander to produce electrical power.

In another embodiment of the invention, a fuel cell system includes a fuel cell stack and a subsystem. The subsystem is adapted to flow a refrigerant through the fuel cell stack to remove thermal energy from the stack.

Advantages and other features of the invention will become apparent from the following drawing, description and claims.

### BRIEF DESCRIPTION OF THE DRAWING

FIG. 1 is a schematic diagram of a fuel cell system.

FIG. 2 is a schematic diagram of a fuel cell system according to an embodiment of the invention.

FIG. 3 is a flow diagram depicting a technique to remove heat from a fuel cell stack according to an embodiment of the invention.

### DETAILED DESCRIPTION

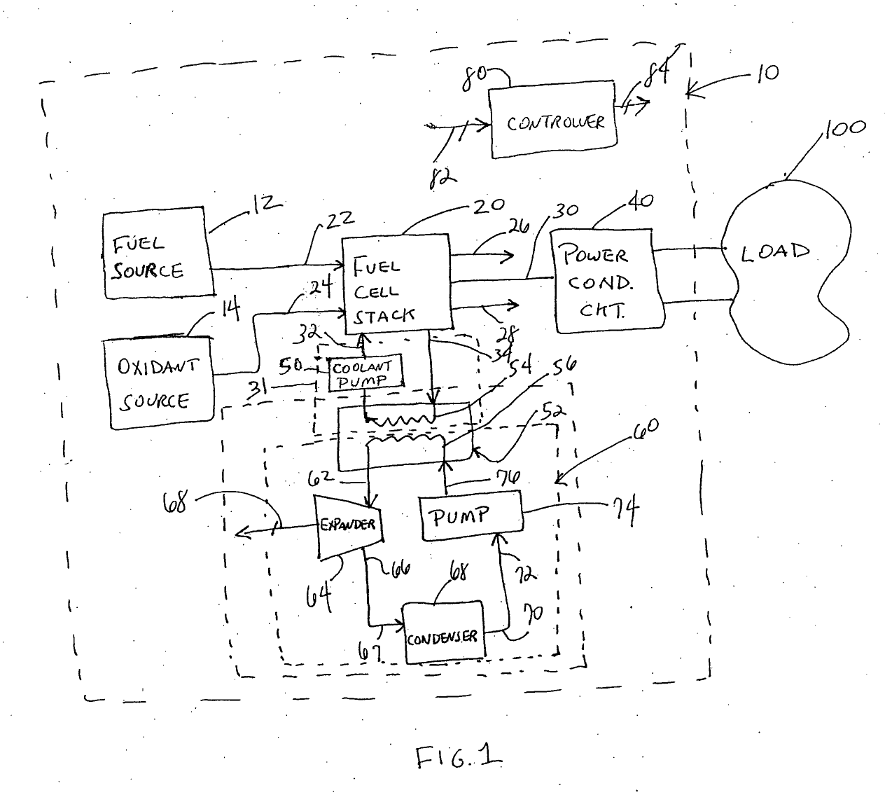

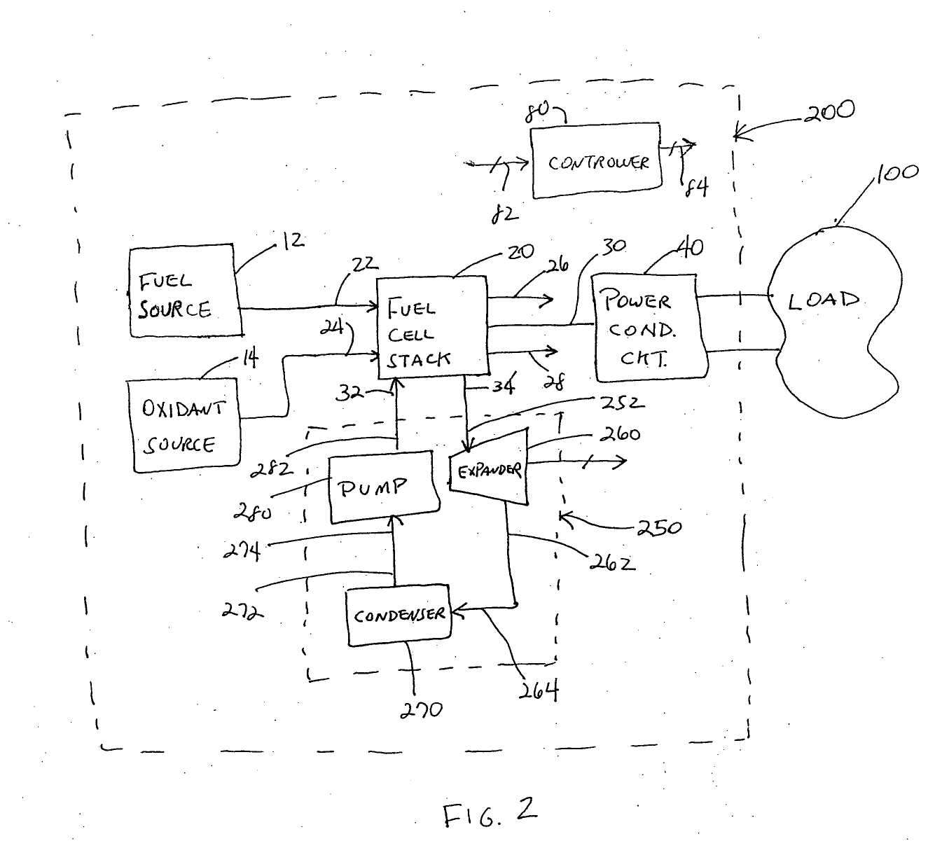

Referring to FIG. 1, a fuel cell system 10 produces electrical power and primary cycle heat. The fuel cell system 10 uses the primary cycle heat to produce additional electricity for purposes of improving the efficiency of the system 10. Unlike a fuel cell system 200 that is described in connection with FIG. 2 (below), the fuel cell system 10 uses both a refrigerant and a coolant to convert the primary cycle heat into electricity. As described below, this approach has an inherent inefficiency, which is removed by the refrigerant-only approach that is used by the fuel cell system 200.

Turning now to the specifics of fuel cell system 10, the system 10 includes a fuel cell stack 20 that produces electrical power for a load 100 in response to incoming fuel and oxidant flows that are received at an anode inlet 22 and a cathode inlet 24, respectively, of the stack 20. In this regard, the fuel cell stack 20 produces a DC output voltage on its output stack terminal 30; and power conditioning circuitry 40 of the fuel cell system 10 conditions the power that is produced by the stack 20 into the appropriate form for the load 100. Therefore, if the load 100 is a DC load, the power conditioning circuitry 40 transforms the DC stack voltage into the appropriate DC level for the load 100. If the load 100 is an AC load, then the power conditioning circuitry 40 converts the DC stack voltage into the appropriate AC voltage that is communicated to the load 100.

As depicted in FIG. 1, the fuel cell stack 20 receives its fuel flow from a fuel source 12, which may be a reformer (and thus, the fuel flow may be reformate) or a hydrogen tank (and thus, the fuel may be hydrogen), as examples. Additionally, the fuel cell stack 20 may receive its oxidant flow from an oxidant source 14, such as an air blower, for example. Other variations are possible and are within the scope of the appended claims.

As mentioned above, in addition to producing electrical power, the fuel cell stack 20 also produces thermal energy, or heat, which is called “primary cycle heat” herein. The primary cycle heat drives a “bottoming cycle” to make additional electricity from the primary cycle heat. More particularly, the fuel cell system 10 includes a coolant circuit 31 that circulates a coolant through the fuel cell stack 20 to remove primary cycle heat; and the fuel cell system 10 includes a refrigerant circuit 60 that is thermally coupled to the coolant circuit 31 to produce electricity in response to thermal energy that is received from the coolant circuit 31.

Turning now to the more specific details, the coolant circuit 31 includes a coolant pump 50 that furnishes coolant to a coolant inlet 32 of the fuel cell stack 20. The coolant flows through the coolant flow channels of the fuel cell stack 20, absorbs heat from the fuel cell stack 20 in its flow through the coolant flow channels and exits the fuel cell stack at a coolant outlet port 34. The exiting coolant passes through a heat sink to remove thermal energy from the coolant so that the coolant may be reintroduced into the stack 20 for purposes of regulating the stack's temperature. As depicted in FIG. 1, the above-referenced heat sink may be one side 54 of a heat exchanger 52 that forms another component of the coolant circuit 31. The thermally coupled other side 56 of the heat exchanger 52, in turn, forms is part of the refrigerant circuit 60 that generates electricity from the primary cycle heat.

In the refrigerant circuit 60, refrigerant that flows through the side 56 of the heat exchanger 52 receives heat from the coolant that flows through the side 56 of the heat exchanger 52. The refrigerant is furnished to an inlet 76 of the heat exchanger side 56 by a pump 74 (of the circuit 60); and the heated refrigerant (in a gaseous state) exits the heat exchanger 52 at an outlet 62. From the outlet 62, the heated refrigerant is directed to an expander 64 of the circuit 60.

The expander 64, which may be a turbine (as an example), responds to the flow of the refrigerant to generate electrical power on electrical output lines 68 of the expander 64. The refrigerant flows from an outlet 66 of the expander 64 into an inlet 67 of a condenser 68 of the circuit 60.

The condenser 68 serves as a low grade heat sink to condense the heated refrigerant to return the refrigerant back to its liquid state. The liquid refrigerant then exits the condenser 68 at an outlet 70 of the condenser 68 and returns to an inlet 72 of the pump 74.

Thus, as can be seen from the configuration that depicted in FIG. 1, system heat is first transferred to a coolant (via the coolant circuit 31), and then the heat is transferred to a phase change material (i.e., the refrigerant) in the refrigerant circuit 60.

Among the other features of the fuel cell system 10, the fuel cell system 10 may include a controller that controls various aspects of the fuel cell system 10. In this regard, the controller 80 may include input terminals 82 for purposes of receiving various status and input signals from components of the fuel cell system as well as receiving commands from other entities. The controller 80 may include output terminals 84 for purposes of controlling various components of the fuel cell system, such as motor and valves, communicating signals to other entities, communicating status messages, communicating commands, etc.

Due to the above-described transfer of heat between two heat transfer media (the coolant and the refrigerant), a large temperature window is not available to transfer heat for purposes of generating electricity. In this regard, the heat carrying capability of the coolant is not as large as the refrigerant. Thus, inefficiency is introduced due to the use of two heat transfer media. Furthermore, the arrangement that is depicted in FIG. 1 increases system complexity in that both the coolant circuit 31 and the refrigerant circuit 60 are used.

Referring to FIG. 2, instead of using coolant, a fuel cell system 200 (see FIG. 2) in accordance with the invention uses only one heat transfer media to capture heat and generate electricity. In this regard, in accordance with embodiments of the invention, the fuel cell system 200 includes a refrigerant circuit 250 that circulates a refrigerant to regulate the temperature of the fuel cell stack 20, capture heat from the fuel cell stack 20 and generate electricity in a bottoming cycle. Thus, the widest temperature window is captured to generate electricity. As a result, more electricity may be produced than with the two heat transfer media arrangement of FIG. 1.

The fuel cell system 200 has a similar design to the fuel cell system 10 (see FIG. 1) with like reference numerals being used to depict similar components. However, the fuel cell systems 10 and 200 have differences. Namely, the refrigerant circuit 250 of the fuel cell system 200 replaces the refrigerant 60 and coolant 31 circuits of the fuel cell system 10. Therefore, unlike the fuel cell system 10, the fuel cell system 200 directly captures primary cycle heat from the fuel cell stack 20 using refrigerant. Thus, the bottoming cycle subsystem 250 furnishes refrigerant to the inlet 32 of the fuel cell stack 20.

The refrigerant is heated and is in its gaseous state when exiting the outlet 34 of the fuel cell stack 20. The heated refrigerant flows through an expander 260 of the refrigerant circuit 60 to produce electrical power on output terminals 261 of the expander 260. The heated refrigerant then flows through an outlet 262 of the expander 260 into an inlet 264 of a condenser 270 of refrigerant circuit 60. In the condenser 270 the refrigerant returns to its liquid state and then exits the condenser 270 at the condenser's outlet 272. The refrigerant, in its liquid form, then returns to an inlet 274 of a pump 280. The pump 280 communicates the refrigerant back through its outlet 282 and into the inlet 32 of the stack.

Among the potential advantages of the above-described arrangement, higher system efficiency is provided, in that more electricity may be produced for a given amount of waste heat. Additionally, system complexity is reduced in that only refrigerant is circulate in the bottoming cycle. For similar reasons, the fuel cell system 200 has a higher reliability than the fuel cell system 10. Other and different advantages may be possible in other embodiments of the invention.

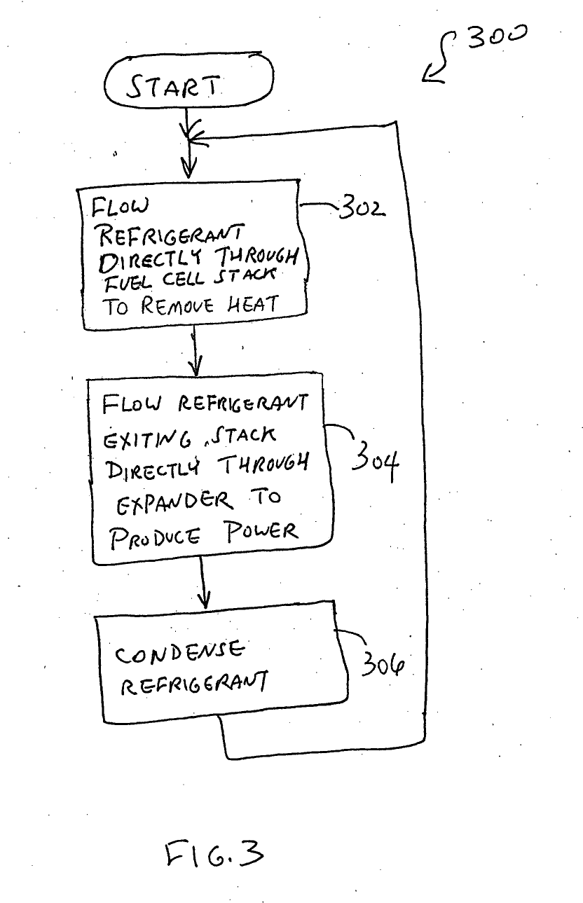

Referring to FIG. 3, to summarize, in accordance with an embodiment of the invention, a technique 300 includes flowing (block 302) refrigerant directly through a fuel cell stack to remove heat. The refrigerant exits the stack and is then flowed (block 304) directly through an expander to produce electrical power. Then, the refrigerant is condensed (block 306) before the cycle begins again with block 302.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell stack, comprising:
flowing a fluid through the fuel cell stack to remove thermal energy from the stack; and
flowing the fluid through an expander to produce electrical power.

2. The method of claim 1, wherein the fluid comprises a refrigerant.

3. The method of claim 1, further comprising:
flowing the fluid through a condenser.

4. The method of claim 1, wherein the act of flowing the fluid through the fuel cell stack comprising transitioning the fluid from a liquid state into a gaseous inside the fuel cell stack.

5. The method of claim 1, wherein the act of flowing the fluid comprises:
pumping the fluid to cause the fluid to flow into flow channels of the fuel cell stack.

6. The method of claim 1, wherein the expander comprises a turbine.

7. The method of claim 1, further comprising:
flowing the fluid from the expander through a condenser; and
receiving the fluid from the condenser and pumping the received fluid to the fuel cell stack.

8. A method usable with a fuel cell stack, comprising:
flowing a refrigerant through the fuel cell stack to remove thermal energy from the stack.

9. The method of claim 8, further comprising:
converting the thermal energy into electrical power.

10. The method of claim 9, wherein the act of converting comprises flowing the refrigerant through an expander.

11. The method of claim 9, further comprising:
flowing the fluid through a condenser.

12. A fuel cell system comprising:
a fuel cell stack; and
a subsystem adapted to flowing a fluid through the fuel cell stack to remove thermal energy from the stack and convert the thermal energy into electrical power.

13. The fuel cell system of claim 12, wherein the subsystem comprises an expander.

14. The fuel cell system of claim 12, wherein the fluid comprises a refrigerant.

15. The fuel cell system of claim 12, wherein the subsystem comprises a condenser adapted to communicate the fluid.

16. The fuel cell system of claim 12, wherein the subsystem comprises:
a pump adapted to pump the fluid into flow channels of the fuel cell stack.

17. A fuel cell system comprising:
a fuel cell stack; and
a subsystem adapted to flow a refrigerant through the fuel cell stack to remove thermal energy from the stack.

18. The fuel cell system of claim 17, wherein the expander is adapted to convert the thermal energy into electrical power.

19. The fuel cell system of claim 17, wherein the act of converting comprises flowing the refrigerant through an expander.

20. The fuel cell system of claim 17, further comprising a condenser adapted to communicate the fluid.
